(19) United States
(12) Patent Application Publication
(10) Pub. No.: US 2009/0021492 A1
(43) Pub. Date: Jan. 22, 2009

(54) Light Emitting Touch Pad and Control System having the same

(76) Inventors: Chih-Lung Wu, Yingge Town (TW); Yi-Hsiang Ho, Jhonghe City (TW)

Correspondence Address: HDSL, P.O. BOX 220746, CHANTILLY, VA, 20153-0746, US

(21) Appl. No.: 11/967,252

(22) Filed: Dec. 30, 2007

(30) Foreign Application Priority Data
Jul. 17, 2007 (TW) 096126025

(51) Int. Cl. G06F 3/042

(52) U.S. Cl. 345/175

(57) ABSTRACT

A light emitting touch pad includes a transparent touch sensor and a light emitting display apparatus. The transparent touch sensor is configured for sensing the position where an object touches the light emitting touch pad. The light emitting display apparatus is disposed at a side of the transparent touch sensor and configured for providing a surface light source emitting light toward the transparent touch sensor.

### BACKGROUND

The present invention relates to a touch pad and a control system having the same, and more particularly to a light emitting touch pad and a control system having the same.

For an electronic apparatus, it is normally necessary to have an input device. Common input devices can be generally divided into two categories. One includes button devices such as keyboards. The other includes pointing devices such as mice or trackballs. With the development of technology, both of these input devices can be replaced by touch pads.

In laptop computers touch pads have been widely used to replace mice. In addition, some control systems have been developed to use touch pads to generate different signals as a user touches different positions of a touch pad. Furthermore, manufactures now provide light sources inside touch pads for users to use touch pads in dark environment. All the touch pads with light sources inside (which are referred as light emitting touch pads in the following) that we commonly see today use point light sources. Referring to FIG. 1, an exploded view of a light emitting touch pad 10 using point light sources. The light emitting touch pad 10 includes a thin film 100 and a touch sensor 110. The touch sensor 110 has multiple small holes formed thereon. Point light sources 111, 112, 113, 114 and 115, which can be light emitting diodes (LEDs), are respectively disposed in the small holes.

However, as shown in FIG. 1, the point light sources in a way undermine the integrity of the touch sensor 110 and further discontinue the linearity of the touch sensor 110 so as to degrade the sensing resolution of the touch sensor 110. In addition, due to the existence of the point light sources, the whole size of the light emitting touch pad 10 is limited and can not be smaller. Furthermore, point lighting may cause uneven surface illumination of the light emitting touch pad 10.

### BRIEF SUMMARY

One objective of the present invention is to provide a light emitting touch pad that not only can provide an even surface illumination but also solve the problem of further miniaturizing the light emitting touch pad that exists in conventional light emitting touch pad with point light sources.

Another objective of the present invention is to provide a control system having a light emitting touch pad. The sensing linearity of the control system is not compromised as in using conventional point light sources.

In one embodiment of the present invention, a light emitting touch pad includes a transparent touch sensor configured for sensing the position where an object touches the light emitting touch pad, and a light emitting display apparatus disposed at a side of the transparent touch sensor and configured for providing a surface light source emitting light toward the transparent touch sensor. The transparent touch sensor can be a resistive touch sensor or a capacitive touch sensor. When the transparent touch sensor is a capacitive touch sensor, the light emitting touch pad can further include an isolation layer. The isolation layer is disposed between the transparent touch sensor and the light emitting display apparatus and configured for reducing electromagnetic interference which the transparent touch sensor receives from the light emitting display apparatus.

In this embodiment, the light emitting touch pad further includes a thin film. The thin film and the light emitting display apparatus being disposed on different sides of the transparent touch sensor. At least a pattern is printed on the thin film. In another embodiment of the present invention, no pattern is printed on the thin film. Instead, the light emitting display apparatus projects a pattern onto the thin film.

The present invention also provides a control system having a light emitting touch pad. The control system includes a light emitting touch pad, a control circuit and a system unit. The light emitting touch pad uses a light emitting display apparatus as a light source. The control circuit is configured for controlling lighting conditions of the light emitting display apparatus according to a control signal and for processing electronic signals generated by the light emitting touch pad. The system unit is configured for controlling the operation of the control circuit and for communicating with the control circuit by signals including the control signal to further control the operation of the control system.

The present invention uses a surface light source in the light emitting touch pad so as to achieve an even surface illumination without degrading the linearity of the touch sensor and to solve the problem of further miniaturizing the light emitting touch pad that exists in conventional light emitting touch pad with point light sources. In addition, because the structure of the touch sensor is not damaged by the light sources, the control system can keep its sensing linearity so that the sensing resolution of the control system is not compromised for providing light in the light emitting touch pad.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded view of a conventional light emitting touch pad using point light sources;

FIG. 2 is circuit block diagram of a control system having a light emitting touch pad in accordance with an embodiment of the present invention;

FIG. 3 illustrates a lighting condition of the light emitting display apparatus in accordance with an embodiment of the present invention; and

FIG. 4 is an exploded view of a light emitting touch pad in accordance with an embodiment of the present invention.

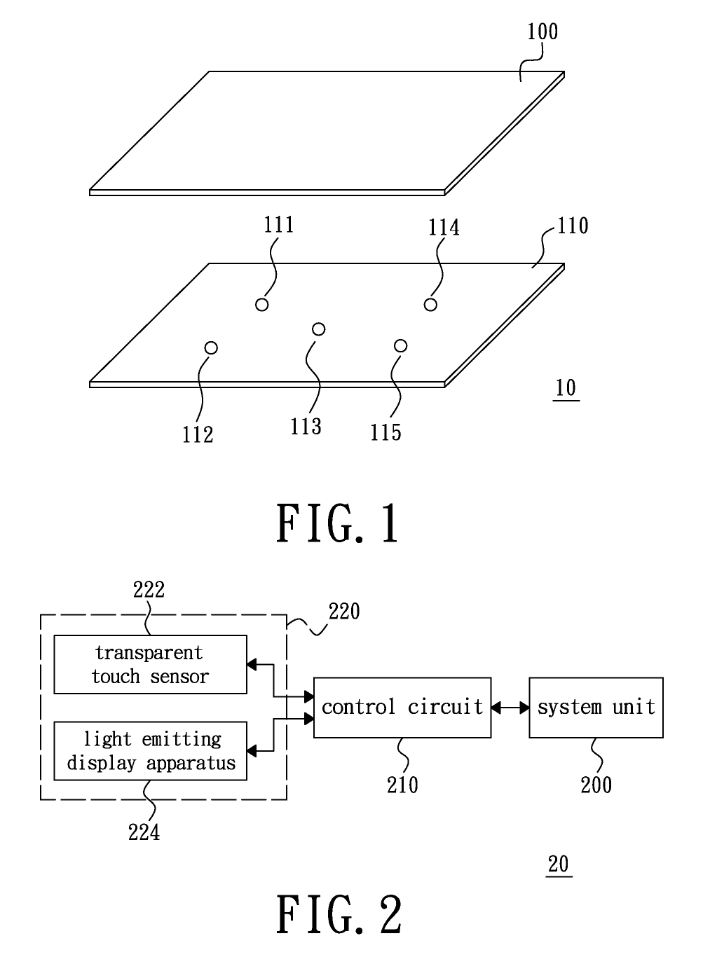

### DETAILED DESCRIPTION

Referring to FIG. 2, a control system 20 having a light emitting touch pad in accordance with a first embodiment of the present invention is provided. The control system 20 includes a system unit 200, a control circuit 210 and a light emitting touch pad 220. The light emitting touch pad 220 includes a transparent touch sensor 222 and a light emitting display apparatus 224.

As a whole, the operation of the control system 20 is controlled by the system unit 200. The light emitting touch pad 220 acts as an interface for inputting data. The control circuit 210 controls the light emitting touch pad 220 according to control signals outputted by the system unit 200. On the other hand, the control circuit 210 can process electronic signals generated by the light emitting touch pad 220 and send the signals, which represent input data inputted by the light emitting touch pad 220, resulted from such processing to the system unit 200. By this way, the system unit 200 can control the operation of the whole control system 20 according to the input data. For example, the control system 20 can be an electronic computer, and the light emitting touch pad 220 may have shapes of numbers and mathematical operators defined thereon. Or, as another example, the control system 20 can be an electronic dictionary, and the light emitting touch pad 220 may have shapes of English alphabets defined thereon.

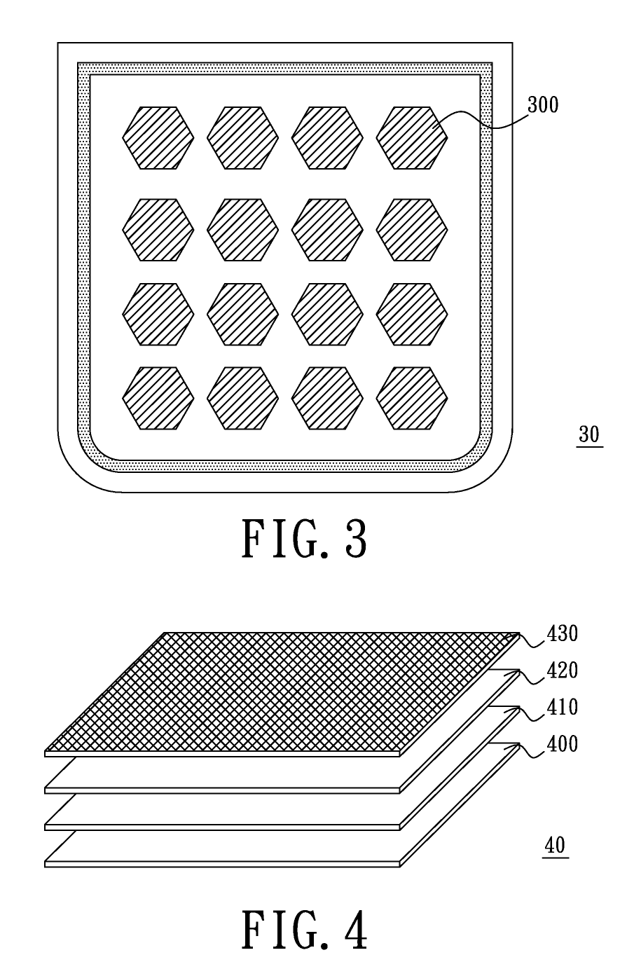

In this embodiment, the light emitting display apparatus 224 is used as a light source in the light emitting touch pad 220. Based on the lighting characteristics of the light emitting display apparatus 224, the control circuit 210 can control the lighting conditions of the light emitting display apparatus 224 such as lighting area, colors and etc. according to the above-mentioned control signals. By this way, a designer can configure the light emitting display apparatus 224 for lighting patterns on the light emitting touch pad 220 and further for conveniently sending users a visual message by changing the lighting conditions of the light emitting display apparatus 224. For example, referring to FIG. 3, the light emitting display apparatus 30 is divided into multiple hexagon regions 300, each of which can be individually controlled by the control circuit 210 as shown in FIG. 2 to emit light or not emit light. The color of the light emitted by each of the hexagon regions 300 can be individually controlled by the control circuit 210 as well.

Referring to FIG. 4, the light emitting touch pad 40 includes a light emitting display apparatus 400, an isolation layer 410, a transparent touch sensor 420 and a thin film 430. The thin film 430 can be a Mylar® film. The light emitting display apparatus 400 and the thin film 430 are respectively disposed on different sides of the touch sensor 420. By this configuration, the light emitted by the light emitting display apparatus 400 can transmit through the transparent touch sensor 420 and project on the thin film 430. A pattern for allowing a user to recognize the different functions of the different regions can be printed on the thin film 430, or alternatively, the same object can be achieved by controlling the lighting conditions of the light emitting display apparatus 400 without printing patterns on the thin film 430. The isolation layer 410 is configured for shielding and reducing the electromagnetic interference (EMI) which the transparent touch sensor 420 receives from the light emitting display apparatus 400. The isolation layer 410 is normally grounded.

Since the purpose of using the thin film 430 is to protect the transparent touch sensor 420, if the transparent touch sensor 420 is fairly hard to be damaged then the thin film 430 may be not necessary. In addition, for common transparent touch sensors, resistive touch sensors are relatively not very susceptible to EMI, so when a resistive touch sensor is used as the transparent touch sensor 420, the isolation layer 410 may be not necessary. Alternatively, even a capacitive touch sensor is used as the transparent touch sensor 420, if there is no EMI phenomenon happening or the EMI does not cause any operational error, the isolation layer 410 may still be eliminated.

In summary, the present invention uses a surface light source in the light emitting touch pad so as to achieve an even surface illumination without degrading the linearity of the touch sensor. In addition, by using the isolation layer to lower the possible EMI associated with using the surface light source, the reliability of the light emitting touch pad is ensured.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A light emitting touch pad, comprising:
a transparent touch sensor configured for sensing a position where an object touches the light emitting touch pad; and
a light emitting display apparatus disposed at a side of the transparent touch sensor and configured for providing a surface light source emitting light toward the transparent touch sensor.

2. The light emitting touch pad of claim 1, wherein the transparent touch sensor is a capacitive touch sensor, further comprising:
an isolation layer disposed between the transparent touch sensor and the light emitting display apparatus for reducing electromagnetic interference which the transparent touch sensor receives from the light emitting display apparatus.

3. The light emitting touch pad of claim 1, wherein the transparent touch sensor is a resistive touch sensor.

4. The light emitting touch pad of claim 1 further comprises a thin film, and the thin film and the light emitting display apparatus being disposed on different sides of the transparent touch sensor.

5. The light emitting touch pad of claim 4, wherein the thin film has at least a pattern printed thereon.

6. A control system having a light emitting touch pad, comprising:
a light emitting touch pad having a light emitting display apparatus as a light source;
a control circuit configured for controlling lighting conditions of the light emitting display apparatus according to a control signal and for processing electronic signals generated by the light emitting touch pad; and
a system unit configured for controlling the operation of the control circuit and for communicating with the control circuit by signals including the control signal to further control the operation of the control system.

7. The control system of claim 6, wherein the light emitting touch pad comprising:
a transparent touch sensor configured for sensing a position where an object touches the light emitting touch pad; and
a light emitting display apparatus disposed at a side of the transparent touch sensor and configured for providing a surface light source emitting light toward the transparent touch sensor.

8. The control system of claim 7, wherein the transparent touch sensor is a capacitive touch sensor, further comprising:
an isolation layer disposed between the transparent touch sensor and the light emitting display apparatus for reducing electromagnetic interference which the transparent touch sensor receives from the light emitting display apparatus.

9. The control system of claim 7, wherein the transparent touch sensor is a resistive touch sensor.

10. The control system of claim 7 further comprises a thin film, and the thin film and the light emitting display apparatus being disposed on different sides of the transparent touch sensor.

11. The control system of claim 10, wherein the thin film has at least a pattern printed thereon.
